(19) United States
(12) Patent Application Publication
(10) Pub. No.: US 2005/0071311 A1
(43) Pub. Date: Mar. 31, 2005

(54) Method and system of partitioning authors on a given topic in a newsgroup into two opposite classes of the authors

(76) Inventors: Rakesh Agrawal, San Jose, CA (US); Sridhar Rajagopalan, Oakland, CA (US); Ramakrishnan Srikani, San Jose, CA (US); Yirong Xu, San Jose, CA (US)

Correspondence Address: LEONARD T. GUZMAN;IBM CORPORATION, INTELLECTUAL PROPERTY LAW, DEPT. C4TA/J2B, 650 HARRY ROAD, San Jose, CA, 95120-6099, US

(21) Appl. No.: 10/676,970

(22) Filed: Sep. 30, 2003

(51) Int. Cl. G06F 7/00

(52) U.S. Cl. 707/1; 705/1

(57) ABSTRACT

The present invention provides a method and system of partitioning authors on a given topic in a newsgroup into two opposite classes of the authors. In an exemplary embodiment, the method and system include identifying all links among the authors, where each link represents a response from one of the authors to another of the authors and analyzing the identified links, where the identified links are assumed to be more likely to be antagonistic links rather than non-antagonistic links. In an exemplary embodiment, the identifying includes assigning a vertex of a graph to each of the authors and assigning an edge of the graph to each interaction between two of the assigned vertices corresponding to two of the authors. In an exemplary embodiment, the analyzing includes solving a min-weight approximately balanced cut problem on a co-citation matrix of the graph, thereby generating the two opposite classes of the authors.

### FIELD OF THE INVENTION

The present invention relates to newsgroups, and particularly relates to a method and system of partitioning authors on a given topic in a newsgroup into two opposite classes of the authors.

### BACKGROUND OF THE INVENTION

Information retrieval has recently witnessed remarkable advances, fueled almost entirely by the growth of the Internet or the Web. The fundamental feature distinguishing recent forms of information retrieval from the classical forms is the pervasive use of link information. More particularly, recent advances in information retrieval over hyperlinked corpora have convincingly demonstrated that links among hyperlinked corpora carry less noisy information than the text in the hyperlinked corpora.

Within a given topic in a newsgroup, postings on the topic and the links among the postings exhibit similar characteristics as the text in hyperlinked corpora and the links among hyperlinked corpora. A typical posting (i.e. a newsgroup posting) consists of one or more quoted lines, or text, from another posting followed by the opinion (i.e. more text) of the author of the typical posting. Such quoting text among postings in a newsgroup form a typical social behavior among the authors of the postings in the newsgroup. In particular, the social behavior or interactions among the authors has the following two components:
(1) the text which is the content of the interaction; and
(2) the link which is the choice of person who an author chooses to interact with.

An interesting characteristic of many newsgroups is that people more frequently respond to a message when they disagree than when they agree. This behavior is in sharp contrast to the Web link graph, where linkage is an indicator of agreement or common interest.

A useful analysis of newsgroup postings is to partition authors of the postings into two opposite classes of authors. Prior art methods based on statistical analysis of text yield low accuracy on such datasets because of the following reasons:
(1) the vocabulary used by the two sides tends to be largely identical; and
(2) many newsgroup postings consist of relatively few words of text.
   Prior art FIG. 1 is a flowchart of the prior art statistical analysis of text technique. In step 110, the statistical analysis of text technique defines a set of features that can appear in a document. In step 120, the technique counts the number of times each of the features occurs in the document. In step 130, the technique represents each document by a document vector. In step 140, the technique applies a machine learning algorithm to the features, the count, and the vectors. The machine learning algorithm could be (a) a Naïve Bayes algorithm, (b) a maximum entropy algorithm, or (c) a support vector machines algorithm.

In addition, such prior art methods for making determinations about values, opinions, biases and judgments purely from a statistical analysis of text are difficult to implement because such determinations require a more detailed linguistic analysis of content or text.

General Prior Art

The work of pioneering social psychologist Milgram set the stage for investigations into social networks and algorithmic aspects of social networks. There have been more recent efforts directed at leveraging social networks algorithmically for diverse purposes such as expertise location, detecting fraud in cellular communications, and mining the network value of customers. In particular, Schwartz and Wood construct a graph using email as links, and analyze the graph to discover shared interests. While their domain consists of interactions between people, their links are indicators of common interest, not antagonism.

Work on incorporating the relationship between objects into the classification process is related prior art. Chakrabarti et al. showed that incorporating hyperlinks into the classifier can substantially improve the accuracy. The work by Neville and Jensen classifies relational data using an iterative method where properties of related objects are dynamically incorporated to improve accuracy. These properties include both known attributes and attributes inferred by the classifier in previous iterations. Other work along these lines include co-learning and probabilistic relational models. Also related is the work on incorporating the clustering of the test set (unlabeled data) when building the classification model.

Pang et al. classify the overall sentiment (either positive or negative) of movie reviews using text-based classification techniques. Their domain appears to have sufficient distinguishing words between the classes for text-based classification to do reasonably well, though interestingly they also note that common vocabulary between the two sides limits classification accuracy.

Max Cut Problem

In graph theory, a max cut problem is known to be NP-complete, and indeed was one of those shown to be so by Karp in his landmark paper. The situation on the problem remained unchanged until 1995, when Goemans and Williamson introduced the idea of using methods from Semidefinite Programming to approximate the solution with guaranteed bounds on the error better than the naive value of 3/4. However, Semidefinite programming methods involve a lot of machinery, and in practice, their efficacy is sometimes questioned.

Therefore, a method and system of partitioning authors on a given topic in a newsgroup into two opposite classes of the authors is needed.

### SUMMARY OF THE INVENTION

The present invention provides a method and system of partitioning authors on a given topic in a newsgroup into two opposite classes of the authors. In an exemplary embodiment, the method and system include (1) identifying all links among the authors, where each link represents a response from one of the authors to another of the authors and (2) analyzing the identified links, where the identified links are assumed to be more likely to be antagonistic links rather than non-antagonistic links. In an exemplary embodiment, the identifying includes (a) assigning a vertex of a graph to each of the authors and (b) assigning an edge of the graph to each interaction between two of the assigned vertices corresponding to two of the authors.

In an exemplary embodiment, the analyzing includes (a) creating a co-citation matrix of the graph, where the co-citation matrix includes the assigned vertices and the assigned edges, (b) setting a weighted edge with a weight of w for each set of two of the assigned vertices only if the number of the authors to whom both members of the set have responded is w, and (c) solving a min-weight approximately balanced cut problem on the co-citation matrix, thereby generating the two opposite classes of the authors. In an exemplary embodiment, the analyzing includes solving a min-weight approximately balanced cut problem on a co-citation matrix of the graph, where the co-citation matrix includes the assigned vertices and the assigned edges, thereby generating the two opposite classes of the authors. In an exemplary embodiment, the analyzing includes solving a max cut problem on the graph, where the graph includes the assigned vertices and the assigned edges, thereby generating the two opposite classes of the authors.

In an exemplary embodiment, the solving includes calculating the second eigenvector of the co-citation matrix, thereby generating the two opposite classes of the authors. In a particular embodiment, the solving further includes applying a Kernighan-Lin heuristic on the second eigenvector of the co-citation matrix.

In an exemplary embodiment, the method and system further include fixing the assigned vertices of the authors who are most prolific. In an exemplary embodiment, the analyzing includes (a) creating a co-citation matrix of the graph, where the co-citation matrix includes the assigned vertices, the assigned edges, and the fixed assigned vertices of the most prolific authors, (b) setting a weighted edge with a weight of w for each set of two of the assigned vertices only if the number of the authors to whom both members of the set have responded is w, and (c) solving a min-weight approximately balanced cut problem on the co-citation matrix, thereby generating the two opposite classes of the authors. In an exemplary embodiment, the analyzing includes solving a max cut problem on the graph, where the graph includes the assigned vertices, the assigned edges, and the fixed assigned vertices of the most prolific authors, thereby generating the two opposite classes of the authors.

The present invention also provides a computer program product usable with a programmable computer having readable program code embodied therein partitioning authors on a given topic in a newsgroup into two opposite classes of the authors. In an exemplary embodiment, the computer program product includes (1) computer readable code for identifying all links among the authors, where each link represents a response from one of the authors to another of the authors and (2) computer readable code for analyzing the identified links, where the identified links are assumed to be more likely to be antagonistic links rather than non-antagonistic links.

### THE FIGURES

FIG. 1 is a flowchart of the prior art statistical analysis of text technique.

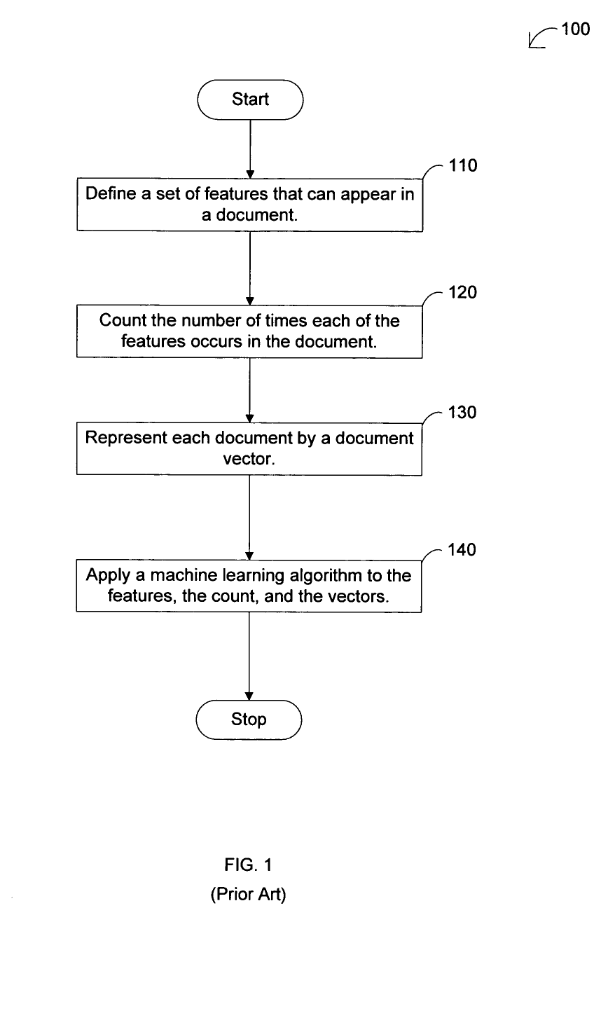

FIG. 2A is a flowchart in accordance with an exemplary embodiment of the resent invention.

FIG. 2B is a flowchart of the identifying step in accordance with an exemplary embodiment of the present invention.

FIG. 2C is a block diagram of the execution of the present invention in accordance with an exemplary embodiment of the present invention.

FIG. 2D is a flowchart of the analyzing step in accordance with an exemplary embodiment of the present invention.

FIG. 2E is a block diagram of the execution of the present invention in accordance with an exemplary embodiment of the present invention.

FIG. 2F is a flowchart of the analyzing step in accordance with an exemplary embodiment of the present invention.

FIG. 2G is a flowchart of the solving step in accordance with an exemplary embodiment of the present invention.

FIG. 3A is a flowchart of the identifying step in accordance with an exemplary embodiment of the present invention.

FIG. 3B is a flowchart of the analyzing step in accordance with an exemplary embodiment of the present invention.

FIG. 3C is a flowchart of the analyzing step in accordance with an exemplary embodiment of the present invention.

FIG. 3D is a flowchart of the solving step in accordance with an exemplary embodiment of the present invention.

### DETAILED DESCRIPTION OF THE INVENTION

The present invention provides a method and system of partitioning authors on a given topic in a newsgroup into two opposite classes of the authors, those who are in favor of the topic (i.e. “for”) and those who are against (i.e. “against”) the topic. The typical social behavior in a newsgroup gives rise to a network or graph in which the vertices of the graph are individuals and the links of the graph represent “responded-to” relationships. Therefore, more particularly, the present invention provides a method and system of partitioning authors into opposite camps within a given topic in a newsgroup by analyzing the graph structure of the responses. The present invention utilizes methods of analyzing link graphs to perform the partitioning.

Quotation Links

The present invention establishes that a quotation link exists between person i and person j if i has quoted from an earlier posting written by j. Quotation links have several interesting social characteristics. For example, quotation links are created without mutual concurrence. In other words, i does not need the permission of j to quote. In addition, in many newsgroups, quotation links are usually “antagonistic”. In other words, it is more likely that the quotation is made by a person challenging or rebutting it rather than by someone supporting it. In this sense, quotation links are not like the Web where linkage tends to imply a tacit endorsement.

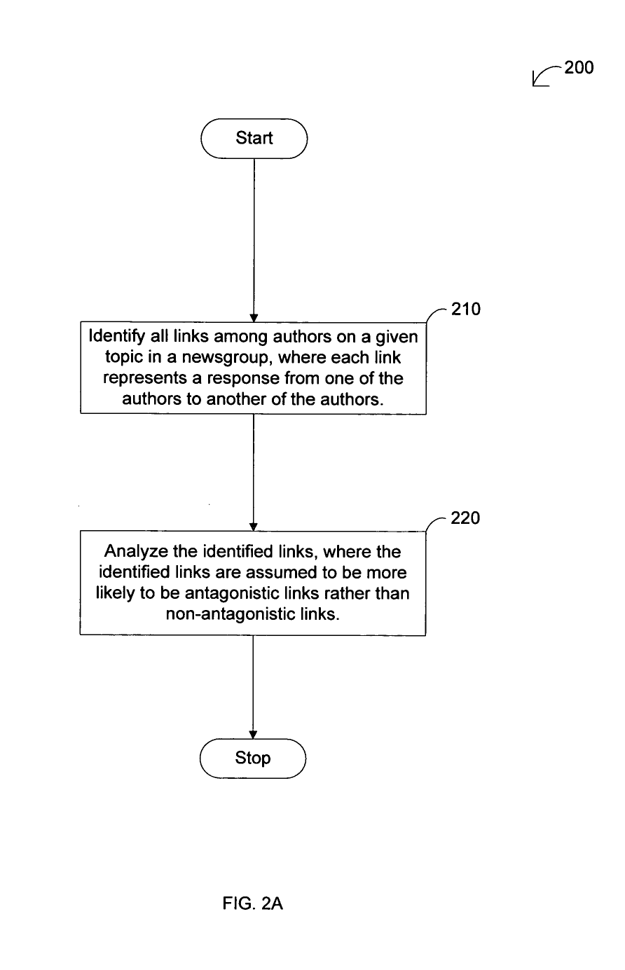

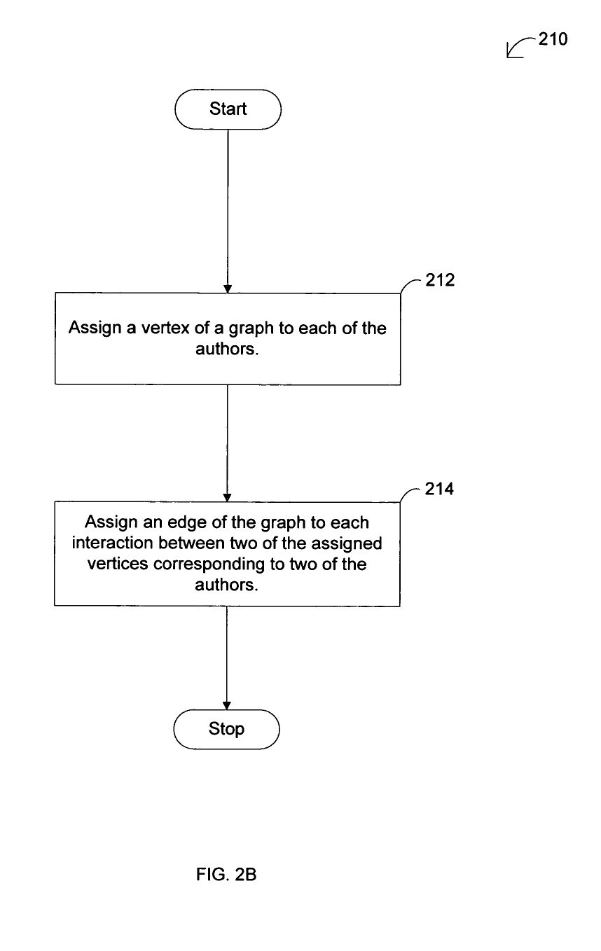

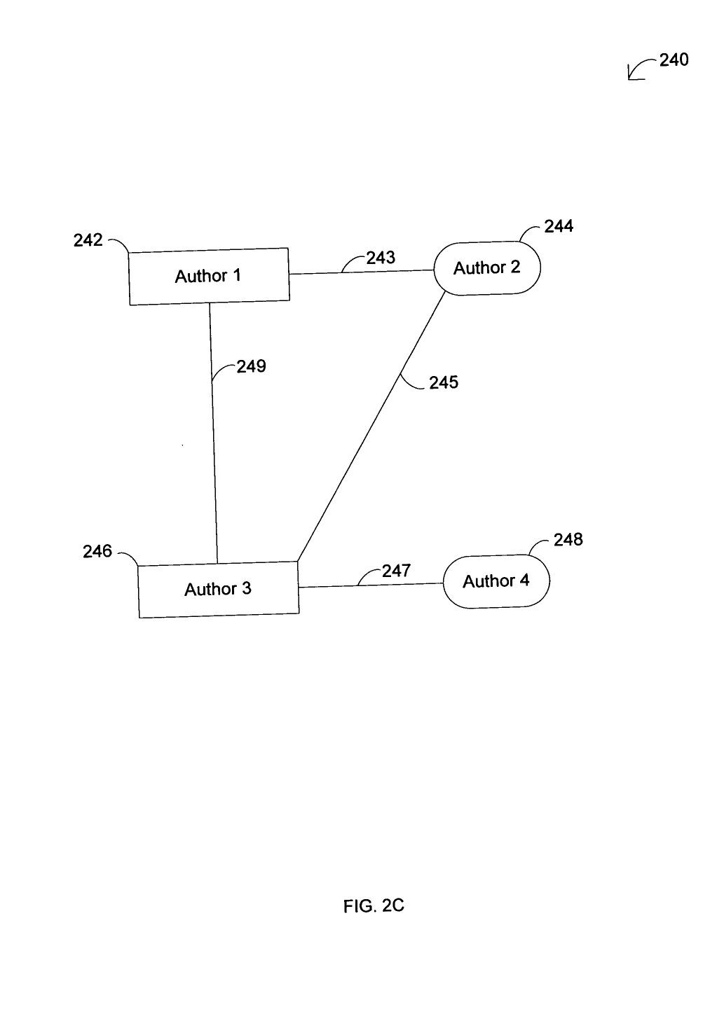

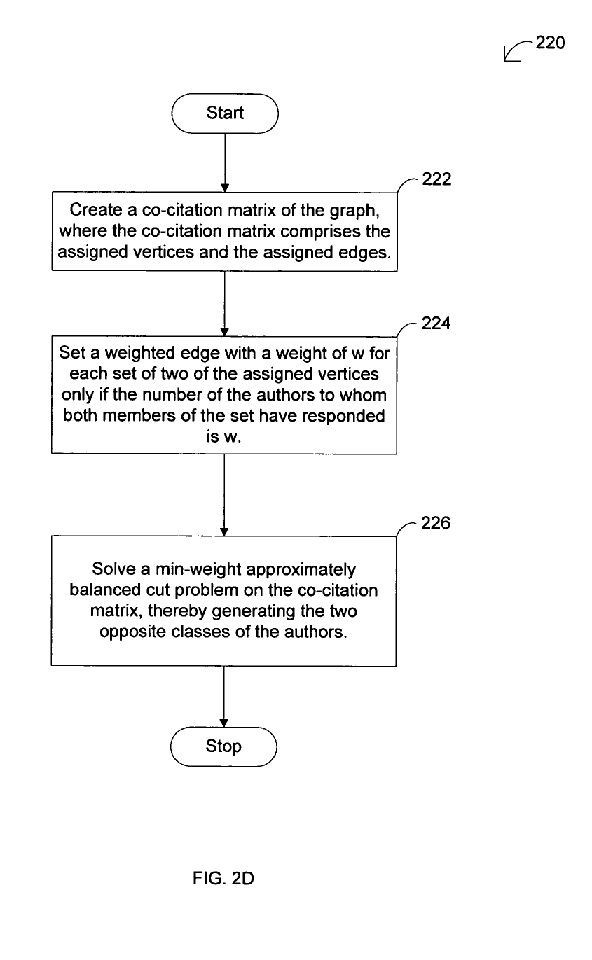

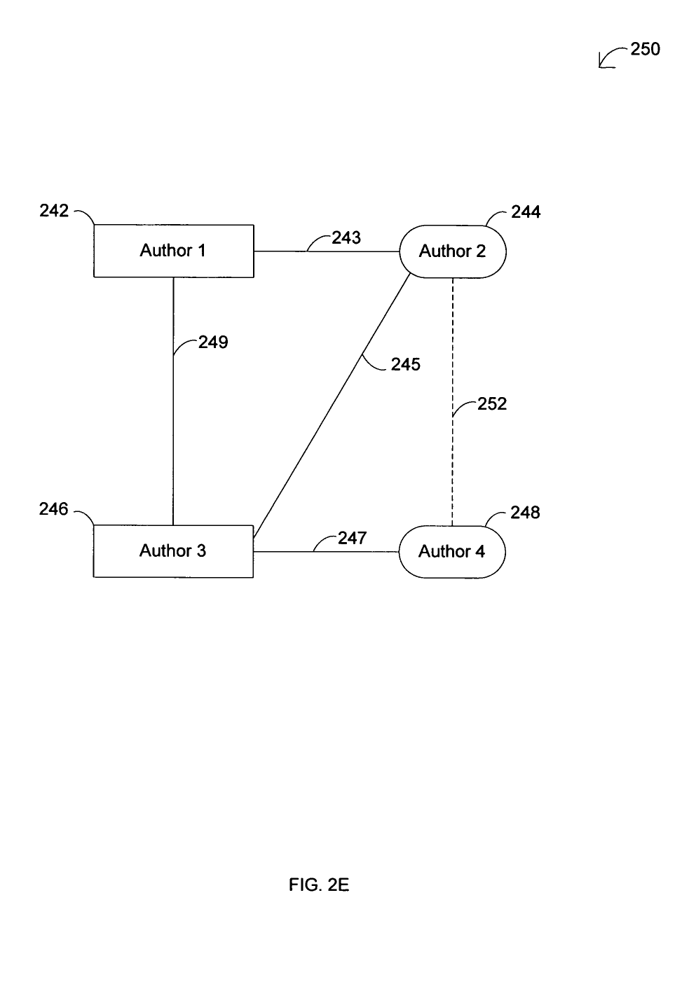

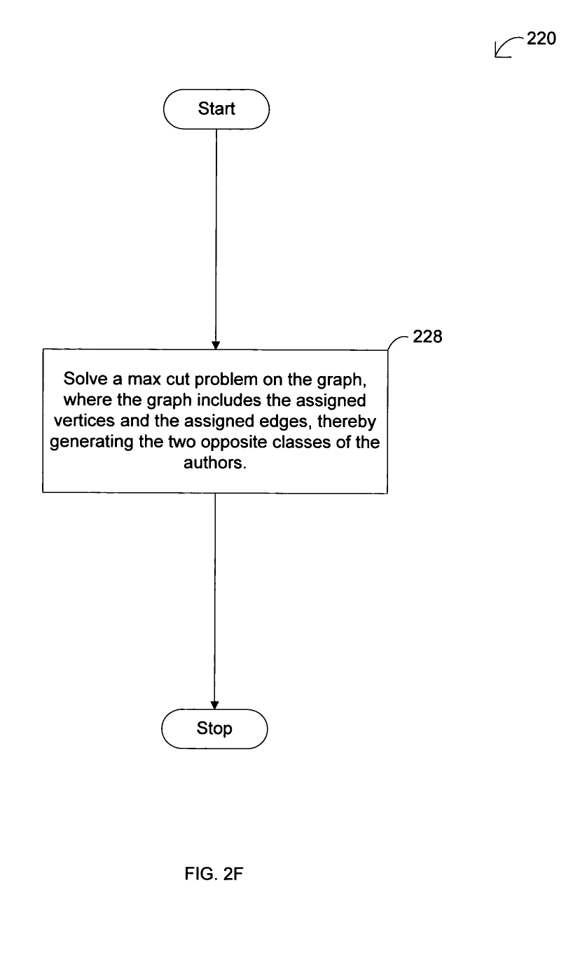

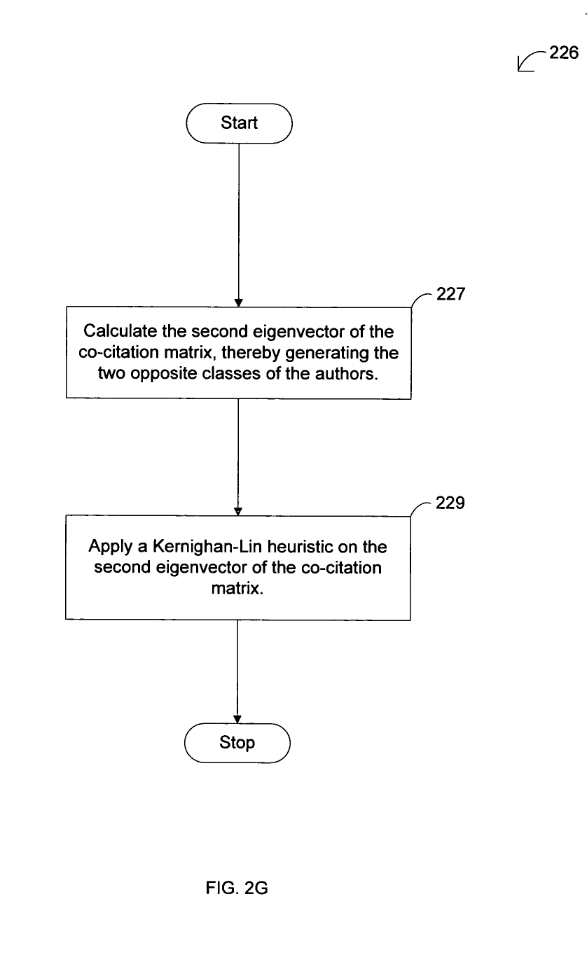

In an exemplary embodiment, as shown in FIG. 2A, the present invention includes a step 210 of identifying all links among authors on a given topic in a newsgroup, where each link represents a response from one of the authors to another of the authors and a step 220 of analyzing the identified links, where the identified links are assumed to be more likely to be antagonistic links rather than non-antagonistic links.

Graph-Theoretic Approach

The present invention includes a graph-theoretic approach for accomplishing the partitioning that completely discounts the text of the postings and only uses the link structure of the network of interactions. The graph-theoretic approach considers a graph
G(V,E)
where the vertex set V has a vertex per participant within the newsgroup discussion. Therefore the total number of vertices in the graph is equal to the number of distinct participants. An edge,
eεE,
e=(v₁,v₂),vᵢεV,
indicates that person v₁ has responded to a posting by person v₂.

In an exemplary embodiment, as shown in FIG. 2B, identifying step 210 includes a step 212 of assigning a vertex of a graph to each of the authors and a step 214 of assigning an edge of the graph to each interaction between two of the assigned vertices corresponding to two of the authors.

As shown in FIG. 2C, in step 212, the present invention assigns vertices 242, 244, 246, and 248 to authors 1, 2, 3, and 4, respectively. In addition, as shown in FIG. 2C, in step 214, the present invention assigns edges 243, 245, 247, and 249 to the interactions between assigned vertices 242 and 244, 244 and 246, 246 and 248, and 242 and 246, respectively.

Unconstrained Graph Partitioning

In an exemplary embodiment, the present invention uses unconstrained graph partitioning as its graph-theoretic approach.

Optimum Partitioning

In an exemplary embodiment, the present invention uses a form of unconstrained graph partitioning called optimum partitioning. Optimum partitioning considers any bipartition of the vertices into two sets F and A, representing thosefor and those against an issue. It assumed that F and A are disjoint and complementary, i.e.,
F∪A=V
and
F∩A=φ.
Such a pair of sets, F and A, can be associated with the cut function,
ƒ(F,A)=|E∩(F×A)|,
the number of edges crossing from F to A.

Optimum Choices

If most edges in a newsgroup graph G represent disagreements, the optimum choice of F and A maximizes
ƒ(F,A).
For such a choice of F and A, the edges
E∩(F×A)
are those that represent antagonistic responses, and the remainder of the edges represent reinforcing interactions.

Max Cut

In an exemplary embodiment, the present invention performs optimum partitioning by solving a max cut problem. In a particular embodiment, the present invention computes F and A optimizing
ƒ
as above, thereby including a graph theoretic approach to classifying or partitioning authors in the newsgroup discussions based solely on link information.

In an exemplary embodiment, as shown in FIG. 2F, analyzing step 220 includes a step 228 of solving a max cut problem on the graph, where the graph includes the assigned vertices and the assigned edges, thereby generating the two opposite classes of the authors.

Min Weight Approximately Balanced Cut

In an exemplary embodiment, the present invention performs optimum partitioning by solving a min weight approximately balanced cut problem. In particular, the present invention performs spectral partitioning for computational efficiency reasons by exploiting the following two facts in optimum partitioning:
(1) rather than being a general graph, optimum partitioning includes a newsgroup graph that is largely a bipartite graph with some noise edges added; and
(2) neither side of the bipartite graph is much smaller than the other, such that it is not the case that
   |F|<<|A|
or vice versa.

With such a newsgroup graph, the present invention can transform the max cut problem into a min-weight approximately balanced cut problem, which in turn can be well approximated by computationally simple spectral methods.

The min-weight approximately balanced cut approach considers the co-citation matrix of the graph G. This graph,
D=GG^{T}
is a graph on the same set of vertices as G. A weighted edge
e=(u₁,v₂)
in D of weight w exists if and only if exactly w vertices,
v₁ . . . v_{w}
exist such that each edge
(u₁,vᵢ)
and
(u₂,vᵢ)
is in G. In other words, w measures the number of people that
u₁
and
u₂
have both responded to w can be used as a measure of “similarity”.

In an exemplary embodiment, as shown in FIG. 2D, analyzing step 220 includes a step 222 of creating a co-citation matrix of the graph, where the co-citation matrix includes the assigned vertices and the assigned edges, a step 224 of setting a weighted edge with a weight of w for each set of two of the assigned vertices only if the number of the authors to whom both members of the set have responded is w, and a step 226 of solving a min-weight approximately balanced cut problem on the co-citation matrix, thereby generating the two opposite classes of the authors.

As shown in FIG. 2E, in steps 222 and 224, the present invention creates a co-citation matrix of the graph, where the co-citation matrix includes the assigned vertices and the assigned edges and sets a weighted edge, such as weighted edge 252 between vertices 244 and 248, with a weight of w for each set of two of the assigned vertices only if the number of the authors to whom both members of the set have responded is w. For example, in an exemplary embodiment, weighted edge 252 is a co-citation link.

In a further embodiment, the present invention uses spectral (or any other) clustering methods to cluster the vertex set into classes. In such an embodiment, the following are true:
(1) an EV Algorithm exists such that the second eigenvector of
   D=GG^{T}
   is a good approximation of the desired bipartition of G; and
(2) an EV+KL Algorithm exists such that Kernighan-Lin heuristic on top of spectral partitioning can improve the quality of partitioning.

In an exemplary embodiment, as shown in FIG. 2G, solving step 226 includes a step 227 of calculating the second eigenvector of the co-citation matrix, thereby generating the two opposite classes of the authors. In a further embodiment, solving step 226 further includes a step 229 of applying a Kernighan-Lin heuristic on the second eigenvector of the co-citation matrix.

Constrained Graph Partitioning

In an exemplary embodiment, the present invention uses constrained graph partitioning as its graph-theoretic approach. In an exemplary embodiment, the present invention partitions a newsgroup graph where the newsgroup has the following characteristics:
(1) a small number of prolific posters in the newsgroup have been categorized; and
(2) the corresponding vertices in the graph have been tagged.
   In an exemplary embodiment, the present invention enforces the constraint that tagged vertices on one side should remain on that side during the partitioning of the graph.

Constrained graph partitioning considers a graph G and two sets of vertices,
C_{F}
and
C_{A},
constrained to be in the sets F and A respectively. In an exemplary embodiment, the present invention finds a bipartition of G that respects this constraint but otherwise optimizes
ƒ(F,A)

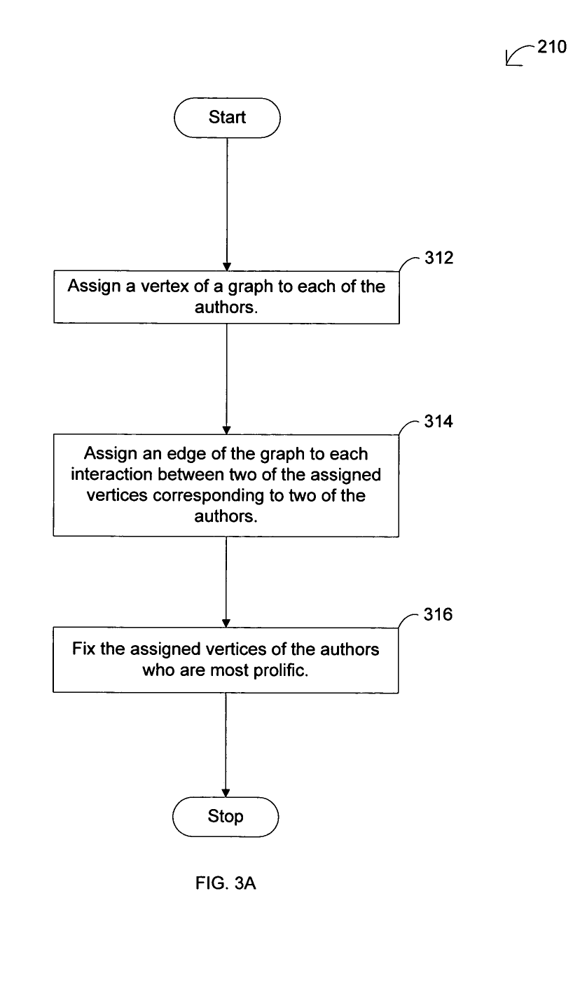

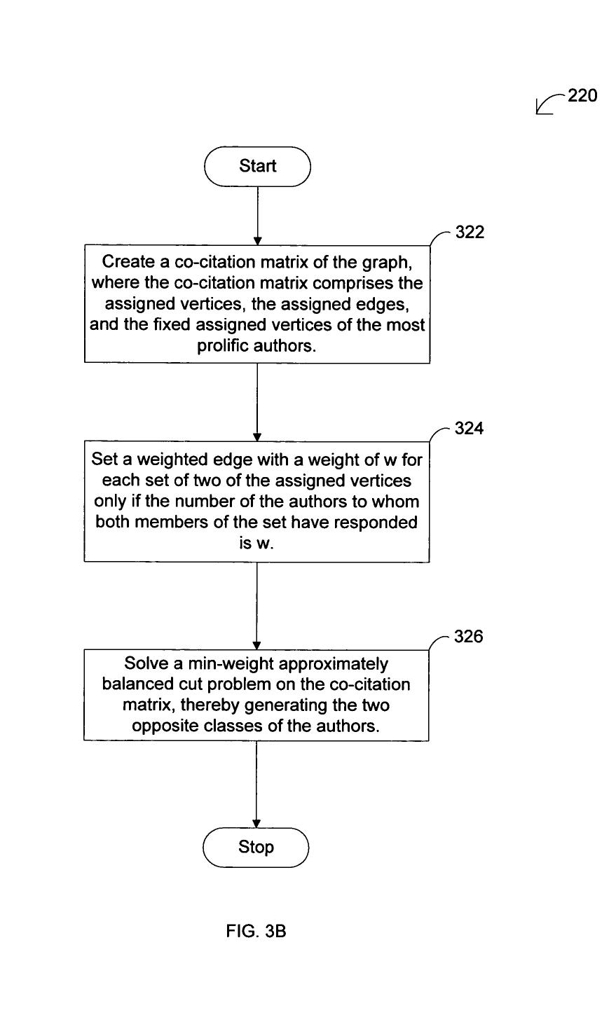

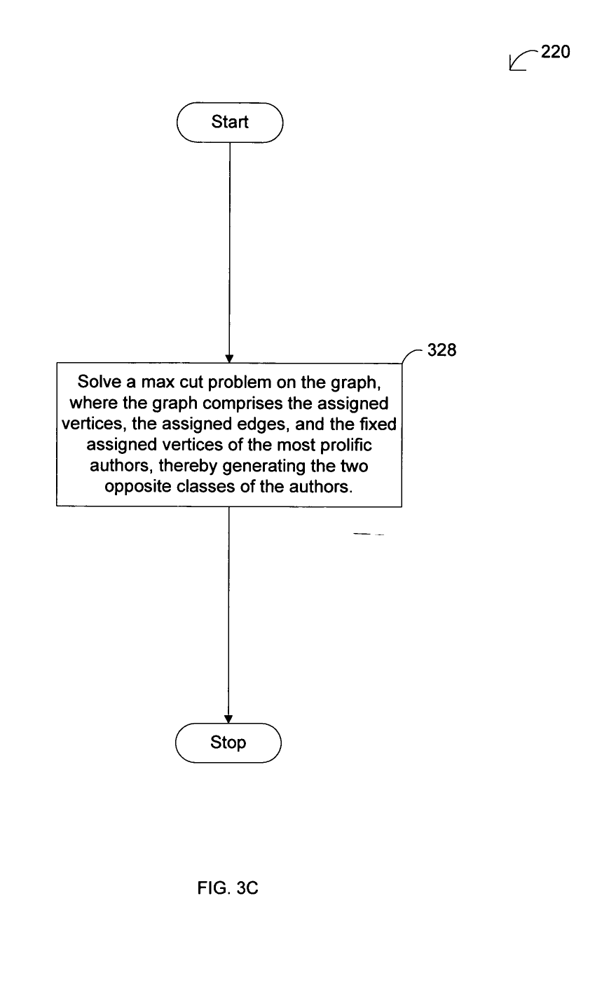

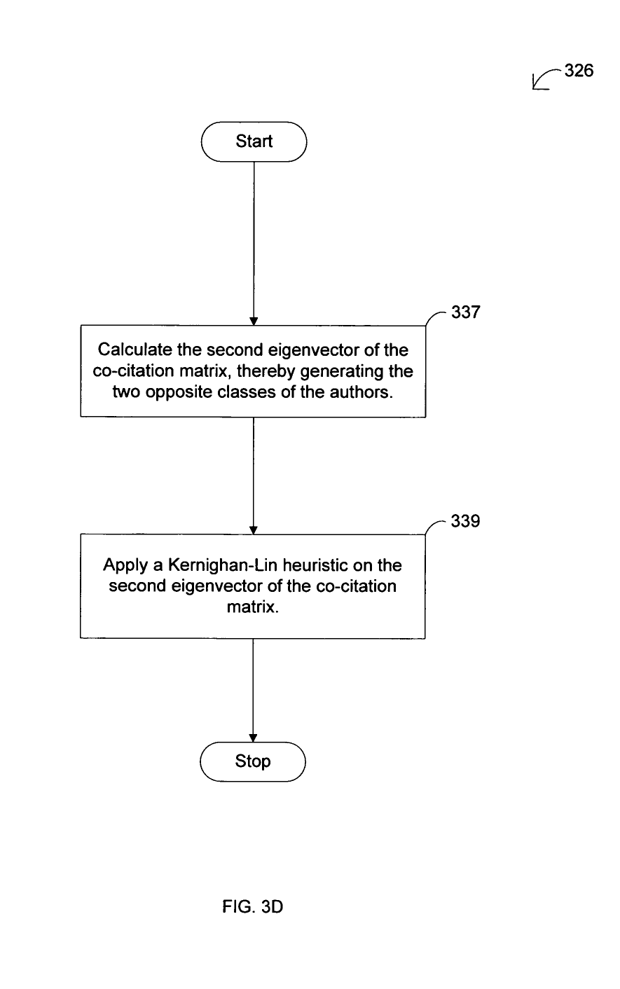

In an exemplary embodiment, as shown in FIG. 3A, identifying step 210 includes a step 312 of assigning a vertex of a graph to each of the authors, a step 314 of assigning an edge of the graph to each interaction between two of the assigned vertices corresponding to two of the authors, and a step 316 of fixing the assigned vertices of the authors who are most prolific.

In an exemplary embodiment, as shown in FIG. 3B, analyzing step 220 includes a step 322 of creating a co-citation matrix of the graph, where the co-citation matrix includes the assigned vertices, the assigned edges, and the fixed assigned vertices of the most prolific authors, a step 324 of setting a weighted edge with a weight of w for each set of two of the assigned vertices only if the number of the authors to whom both members of the set have responded is w, and a step 326 of solving a min-weight approximately balanced cut problem on the co-citation matrix, thereby generating the two opposite classes of the authors.

In an exemplary embodiment, as shown in FIG. 3C, analyzing step 220 includes a step 328 of solving a max cut problem on the graph, where the graph includes the assigned vertices, the assigned edges, and the fixed assigned vertices of the most prolific authors, thereby generating the two opposite classes of the authors.

Partitioning

The present invention achieves the constrained partitioning by doing the following:
(1) the present invention condenses all of the positive vertices into a single condensed positive vertex and condenses all of the negative vertices into a single condensed negative vertex, before partitioning the newsgroup graph;
(2) when using the EV algorithm for partitioning, the present invention checks that the final result has the condensed positive and negative vertices on the correct sides, thereby using a constrained EV algorithm;
   when using the EV+KL algorithm for partitioning, the present invention checks that the final result has the condensed positive and negative vertices on the correct sides, thereby using a constrained EV+KL algorithm.

In an exemplary embodiment, as shown in FIG. 3D, solving step 326 includes a step 337 of calculating the second eigenvector of the co-citation matrix, thereby generating the two opposite classes of the authors and a step 339 of applying a Kernighan-Lin heuristic on the second eigenvector of the co-citation matrix.

Conclusion

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

1. A method of partitioning authors on a given topic in a newsgroup into two opposite classes of the authors, the method comprising:
identifying all links among the authors, wherein each link represents a response from one of the authors to another of the authors; and
analyzing the identified links, wherein the identified links are assumed to be more likely to be antagonistic links rather than non-antagonistic links.

2. The method of claim 1 wherein the identifying comprises:
assigning a vertex of a graph to each of the authors; and
assigning an edge of the graph to each interaction between two of the assigned vertices corresponding to two of the authors.

3. The method of claim 2 wherein the analyzing comprises:
creating a co-citation matrix of the graph, wherein the co-citation matrix comprises the assigned vertices and the assigned edges;
setting a weighted edge with a weight of w for each set of two of the assigned vertices only if the number of the authors to whom both members of the set have responded is w; and
solving a min-weight approximately balanced cut problem on the co-citation matrix, thereby generating the two opposite classes of the authors.

4. The method of claim 2 wherein the analyzing comprises solving a max cut problem on the graph, wherein the graph comprises the assigned vertices and the assigned edges, thereby generating the two opposite classes of the authors.

5. The method of claim 3 wherein the solving comprises calculating the second eigenvector of the co-citation matrix, thereby generating the two opposite classes of the authors.

6. The method of claim 5 further comprising applying a Kemighan-Lin heuristic on the second eigenvector of the co-citation matrix.

7. The method of claim 2 further comprising fixing the assigned vertices of the authors who are most prolific.

8. The method of claim 7 wherein the analyzing comprises:
creating a co-citation matrix of the graph, wherein the co-citation matrix comprises the assigned vertices, the assigned edges, and the fixed assigned vertices of the most prolific authors;
setting a weighted edge with a weight of w for each set of two of the assigned vertices only if the number of the authors to whom both members of the set have responded is w; and
solving a min-weight approximately balanced cut problem on the co-citation matrix, thereby generating the two opposite classes of the authors.

9. The method of claim 7 wherein the analyzing comprises solving a max cut problem on the graph, wherein the graph comprises the assigned vertices, the assigned edges, and the fixed assigned vertices of the most prolific authors, thereby generating the two opposite classes of the authors.

10. The method of claim 8 wherein the solving comprises calculating the second eigenvector of the co-citation matrix, thereby generating the two opposite classes of the authors.

11. The method of claim 10 further comprising applying a Kemighan-Lin heuristic on the second eigenvector of the co-citation matrix.

12. A system of partitioning authors on a given topic in a newsgroup into two opposite classes of the authors, the system comprising:
an identifying module configured to identify all links among the authors, wherein each link represents a response from one of the authors to another of the authors; and
an analyzing module configured to analyze the identified links, wherein the identified links are assumed to be more likely to be antagonistic links rather than non-antagonistic links.

13. The system of claim 12 wherein the identifying module comprises:
a vertex assigning module configured to assign a vertex of a graph to each of the authors; and
an edge assigning module configured to assign an edge of the graph to each interaction between two of the assigned vertices corresponding to two of the authors.

14. The system of claim 13 wherein the analyzing module comprises:
a creating module configured to create a co-citation matrix of the graph, wherein the co-citation matrix comprises the assigned vertices and the assigned edges;
a setting module configured to set a weighted edge with a weight of w for each set of two of the assigned vertices only if the number of the authors to whom both members of the set have responded is w; and
a solving module configured to solve a min-weight approximately balanced cut problem on the co-citation matrix, thereby generating the two opposite classes of the authors.

15. The system of claim 13 wherein the analyzing module comprises a solving module configured to solve a max cut problem on the graph, wherein the graph comprises the assigned vertices and the assigned edges, thereby generating the two opposite classes of the authors.

16. The system of claim 14 wherein the solving module comprises a calculating module configured to calculate the second eigenvector of the co-citation matrix, thereby generating the two opposite classes of the authors.

17. The system of claim 13 further comprising a fixing module configured to fix the assigned vertices of the authors who are most prolific.

18. The system of claim 17 wherein the analyzing module comprises:
a creating module configured to create a co-citation matrix of the graph, wherein the co-citation matrix comprises the assigned vertices, the assigned edges, and the fixed assigned vertices of the most prolific authors;
a setting module configured to set a weighted edge with a weight of w for each set of two of the assigned vertices only if the number of the authors to whom both members of the set have responded is w; and
a solving module configured to solve a min-weight approximately balanced cut problem on the co-citation matrix, thereby generating the two opposite classes of the authors.

19. The system of claim 17 wherein the analyzing module comprises a solving module configured to solve a max cut problem on the graph, wherein the graph comprises the assigned vertices, the assigned edges, and the fixed assigned vertices of the most prolific authors, thereby generating the two opposite classes of the authors.

20. A computer program product usable with a programmable computer having readable program code embodied therein partitioning authors on a given topic in a newsgroup into two opposite classes of the authors, the computer program product comprising:
computer readable code for identifying all links among the authors, wherein each link represents a response from one of the authors to another of the authors; and
computer readable code for analyzing the identified links, wherein the identified links are assumed to be more likely to be antagonistic links rather than non-antagonistic links.
